(19) United States
(12) Patent Application Publication
(10) Pub. No.: US 2018/0114368 A1
(43) Pub. Date: Apr. 26, 2018

(54) THREE-DIMENSIONAL MODEL MANIPULATION AND RENDERING

(71) Applicant: ADOBE SYSTEMS INCORPORATED, San Jose, CA (US)

(72) Inventor: Sebastian MARKETSMUELLER, San Francisco, CA (US)

(21) Appl. No.: 15/334,223

(22) Filed: Oct. 25, 2016

(51) Int. Cl. G06T 19/20; G06F 3/0488; G06T 17/10; G06T 17/20; G06F 3/0482

(52) U.S. Cl. CPC G06T 19/20; G06F 3/04883; G06F 3/0482; G06T 17/205; G06T 17/10

(57) ABSTRACT

Systems and methods are disclosed herein for editing a three-dimensional (3D) model using a volume-based representation of the 3D model. An exemplary method determines a first mesh-based representation of the 3D model based on a first volume-based representation of the 3D model. A first view of the first mesh-based representation of the 3D model is provided for display on the user interface. When an edit for the 3D model is received on the user interface, the first volume-based representation is modified based on the edit to create a second volume-based representation of the 3D model. Modifying the first volume-based representation involves modifying the volume density of the 3D model. A second mesh-based representation of the 3D model is then determined based on the second volume-based representation and a second view of the second mesh-based representation of the 3D model is provided for display on the user interface.

### TECHNICAL FIELD

This disclosure relates generally to computer-implemented methods and systems and more particularly relates to improving image manipulation and rendering of three-dimensional representations of objects and providing a system and method to enable use of two-dimensional type tools in manipulating three-dimensional representations of objects.

### BACKGROUND

Existing computer systems used to create and edit three-dimensional representations of objects have a steep learning curve. Using these systems requires techniques and skills not typically held by designers of two-dimensional images. Examples of existing three-dimensional editing and modelling software include 3D Studio® and Maya® by Autodesk®, and ZBrush® by Pixologic®. The steep learning curve of these systems is at least partially caused by the way three-dimensional shapes are represented and the user interactions needed to edit those representations. For example, three-dimensional surfaces are often represented as a “mesh” of geometric shapes, or polygons. In many cases, these meshes comprise a plurality of triangles which an editor manipulates with tools specific to the triangle's features, such as vertices, edges, faces and the like. In cases where a surface is represented by many small triangles these editing tools require precise manipulation that may be unattainable in touch-based tablets, virtual reality experiences or other systems where needed precision is unavailable.

Various two-dimensional image editing systems are also available. An example of such a system is Photoshop® by Adobe Systems, Inc. of San Jose, Calif. Two-dimensional image editing systems typically includes a variety of widely-understood, two-dimensional editing tools, including but not limited to two-dimensional brushes, filters, and layers. Two-dimensional editing tools do not operate on three-dimensional mesh representations and thus have been unavailable in systems used to create and edit three-dimensional representations of objects.

### SUMMARY

Systems and methods are disclosed herein for editing a three-dimensional (3D) model. An exemplary method involves providing, obtaining and/or storing a first volume-based representation of the 3D model where the first volume-based representation identifies volume densities of the 3D model at multiple locations in a 3D workspace. In one example, the first volume-based representation includes a group of stacked two-dimensional (2D) cross sections of the 3D model at intervals and are represented by a number of image pixels. The method further includes determining a first mesh-based representation of the 3D model based on the first volume-based representation and providing a first view of the first mesh-based representation of the 3D model for display on the user interface. The user interface may include high-end graphics editing monitors as well as those with less resolution including touch-based interfaces and virtual reality environments. The method further includes receiving an edit for the 3D model displayed on the user interface.

Once the edit is received, the method modifies the first volume-based representation based on the edit to create a second volume-based representation of the 3D model, where modifying the first volume-based representation includes modifying the volume density of the 3D model. The method further includes determining a second mesh-based representation of the 3D model based on the second volume-based representation and providing a second view of the second mesh-based representation of the 3D model for display on the user interface

These illustrative features are mentioned not to limit or define the disclosure, but to provide examples to aid understanding thereof. Additional embodiments are discussed in the Detailed Description, and further description is provided there.

### BRIEF DESCRIPTION OF THE FIGURES

These and other features, embodiments, and advantages of the present disclosure are better understood when the following Detailed Description is read with reference to the accompanying drawings.

FIG. 1 is a diagram of an environment in which one or more techniques of the invention can be practiced.

FIG. 2 illustrates a conceptual system and method for editing a 3D model.

FIG. 3 illustrates an example tool set for editing a 3D model.

FIG. 4 is a flow chart illustrating an exemplary method for editing a 3D model.

FIG. 5 illustrates part of an example progression of an edit of a 3D model.

FIG. 6 illustrates another part of the example progression of an edit of a 3D model of FIG. 5.

FIG. 7 illustrates another part of the example progression of an edit of a 3D model of FIG. 5.

FIG. 8 illustrates part of an example progression of an edit of a 3D model.

FIG. 9 illustrates another part of the example progression of an edit of a 3D model of FIG. 8.

FIG. 10 is a block diagram depicting an example hardware implementation.

### DETAILED DESCRIPTION

As described above, existing methods and systems for editing a 3D model require users to master specific, often new and non-intuitive editing tools. Traditional 3D packages edit a surface data structure or mesh (either triangles or subdivision surfaces) directly. This requires a lot of experience and precision and experience which creates a huge barrier of entry for novice 3D users. Also, in some environments, like touch-based tablet computers or in virtual reality experiences, precision editing is not readily available.

This disclosure describes techniques that create and edit a 3D model electronically. The techniques include maintaining two representations of a 3D workspace containing the 3D model, namely a volume-based representation and a mesh-based representation as will be more completely discussed below. By representing the 3D model in two different ways, as a volume-based representation and a mesh-based representation, various advantages are achieved. The mesh-based representation is available for rendering and displaying the 3D model boundaries on the user interface. The mesh-based representation can also be exported to mesh-based computer-aided design (CAD) and other rendering/editing applications and/or printed. The volume-based representation is available to support more familiar creation and editing techniques. Thus, the user interface can use the mesh-based representation to display the 3D model on an editing canvas with which the user can interact. In addition, the user is able to indicate desired edits with space-based tools that specify changes using the general 3D coordinate space. Unlike with prior systems, the user edits do not have to correspond to specific mesh vertices necessary to edit in the mesh-based representation of a 3D model. For example, the user can simply use a brush “painting” tool in a desired area without regard to precise locations of mesh vertices to make edits in that area. In other words, maintaining both a mesh and volumetric representation enables a more intuitive way to edit a 3D model by leveraging existing 2D tools already familiar to users, such as allowing users to use a familiar 2D brush tool that is adapted to edit the volumetric representation. This type of space-based editing is possible because the edits are implemented by initially altering the volume-based representation, and then using that altered volume-based representation to alter the mesh-based representation. As a specific example, if the user paints to add to the side of an object, the initial volume-based representation is changed to add volume in that area resulting in an altered volume-based representation. Then the initial mesh-based representation is revised to an altered mesh-based representation of a surface of the object based on that added volume. The user is thus able to use techniques that are conceptually familiar from two-dimensional editing systems such as Adobe's Photoshop® software. Examples of such techniques include, but are not limited to, techniques using tools like brushing, filtering, and layers but in a 3D context. Furthermore, using a volume-based representation enables less precise editing, which is desirable for touch or virtual reality interfaces.

The volume-based representation of a 3D model may be implemented in a density volume data structure. In one embodiment, the density volume data structure is a stack of grey scale images or cross sections through the 3D workspace. Every element in the grey scale cross sections represents a density value. Other exemplary volume data structures are implemented in tiled form or as a sparse octree data structure. During editing, the system draws, filters, or blends affected elements in the stack of grey scale cross sections based on the edit performed by the user. For example, if the user paints in a new area, the system adds volume density to elements in the stack of grey scale cross sections corresponding to that area in the 3D workspace.

The volume data is converted to a mesh to allow rendering on the user interface and exporting. This conversion can be accomplished via an algorithm that creates a geometric surface from volume-based data. One known example of such as algorithm is known as the “Marching Cubes” algorithm. In one embodiment, the system applies the algorithm to the entire 3D workspace recursively. This enables the system to maintain the two representations of the 3D workspace, volume and mesh, simultaneously or nearly simultaneously. This in turn allows the user to see the current mesh-based representation of the 3D model on the display and indicate further desired edits on the display, while the system applies the desired edits on the volume-based representation of the 3D model in real-time or as near to real-time as the computing and graphic speeds in use permit.

In another embodiment the system runs the algorithm on just the edited region while the user is making edits. In this embodiment, only areas of the volume-based representation that have changed density values are processed by the algorithm to locate triangles, for example, in the mesh within a region, remove them, and then append new, edited, ones resulting in the altered mesh-based representation displayed to the user.

As used herein, the phrase “computing device” refers to any electronic component, machine, equipment, or system that can be instructed to carry out operations. Computing devices will typically, but not necessarily, include a processor that is communicatively coupled to a memory and that executes computer-executable program code and/or accesses information stored in memory or other storage. Examples of computing devices include, but are not limited to, desktop computers, laptop computers, server computers, tablets, telephones, mobile telephones, televisions, portable data assistant (PDA), e-readers, portable game units, smart watches, etc.

As used herein, the phrase “three-dimensional model” or “3D model” refers to an electronic representation of an object to be edited.

As used herein, the phrase “3D workspace” refers to a three-dimensional area in which a 3D model is depicted and edited.

As used herein, the phrase “volume density values” refers to values in a representation of a 3D model that identify the density of the model at particular locations within a 3D workspace. These volume density values are used to determine a mesh representing a surface of the 3D model, for example, where the surface surrounds all density values above a predetermined or user-specified threshold.

As used herein, the phrase “volume-based representation” refers to one way to represent a three-dimensional model. A series of volume densities, or values, of the 3D model are sampled at multiple locations in a 3D workspace. In one example, a volume-based representation includes a group of stacked two-dimensional (2D) cross sections of the 3D workspace at intervals. Locations where the cross section intersects the 3D model are represented as one value and locations outside of the 3D model are represented as another value.

As used herein, the phrase “mesh-based representation” refers to a represent a three-dimensional model that uses a surface formed by combining planar polygons. The surface of a 3D model can be represented by a mesh-based representation that includes a plurality of polygons connected to one another to form a surface of the 3D model. In one example, a mesh-based representation depicts a surface with a plurality of connected triangles.

As used herein, the phrase “edit” refers to creating or altering a 3D model.

As used herein, the phrase “touch-based interface” refers to user interface display capable of sensing interaction by a user's finger or stylus on the display.

As used herein the terms “brush” or “brushing” refers to a method of applying an edit to discrete portions of the 3D workspace using, for example, a tool or pointing device. As one specific example, a brush makes changes in a spatial domain at a location or along a path controlled by a user. The brush includes characteristics such as shape, size and effects including adding to or removing from a 3D model.

As used herein the terms “filter” or “filtering” refers to a method of applying an edit applied to an area of the 3D workspace. The area can include the entire 3D workspace or an area within it, such as an area selected by a user. As a specific example, a transformation such as convolution or blurring changes density values in the signal domain within the area identified in the 3D workspace.

As used herein the term “selection mask” of a 3D model refers to a user indicating an area or areas of the 3D workspace to select while masking or excluding the areas outside of the selection.

As used herein the terms “clone” or “cloning” refer to an edit that duplicates one part of an object to another part of the same object or one 3D workspace to another 3D workspace. The clone tool is useful for duplicating objects or covering a defect in a part of an object. The tool acts on a set sampling point on the source location. Depending on tool options including brush tip size and shape, the tool reproduces the sampling point in the new location.

As used herein the terms “blur” or “blurring” refer to an edit that removes detail from the 3D model in an area effectively blurring the object. As a specific example, a Gaussian filter acts on an area identified by the brush tip or the area identified for filtering.

As used herein the term “noise filter” refers to an edit that adds density values uniformly or randomly over an area to provide a texture to a 3D model. Alternately, the term refers to a filter that removes density values to reduce texture or smooth an area of a 3D model.

As used herein the terms “smudge” or “smudging” refers an edit that simulates dragging a finger through wet paint or clay. The smudge effect acts on the environment where the stroke begins and pushes it in the direction that the tool is moved based on tool options such as size, shape and blending.

As used herein the term “pixelate” refers to an edit that combines or averages neighboring pixel values to produce distortions in the 3D model.

### Exemplary Computing Environment

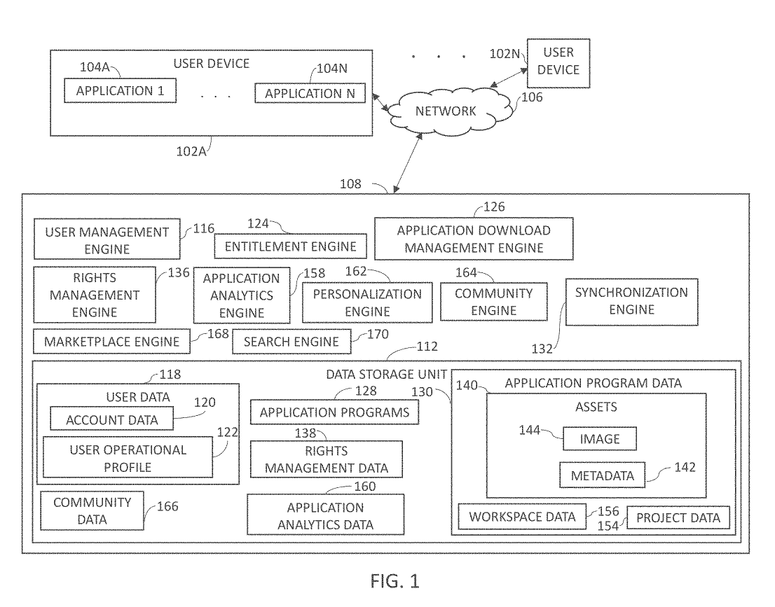

FIG. 1 is a diagram of an environment 100 in which one or more embodiments of the present disclosure can be practiced. The environment 100 includes one or more user devices, such as a user device 102A up to a user device 102N. Each of the user devices is connected to a creative apparatus 108 via a network 106. Users of the user devices uses various products, applications, or services supported by the creative apparatus 108 via the network 106. The user devices correspond to various users. Examples of the users include, but are not limited to, creative professionals or hobbyists who use creative tools to generate, edit, track, or manage creative content, end users, administrators, advertisers, publishers, developers, content owners, content managers, content creators, content viewers, content consumers, designers, editors, any combination of these users, or any other user who uses digital tools to create, view, edit, track, or manage digital experiences.

Digital tool, as described herein, includes a tool that is used for performing a function or a workflow electronically. Examples of the digital tool include, but are not limited to, content creation tool, content editing tool, content publishing tool, content tracking tool, content managing tool, content printing tool, content consumption tool, any combination of these tools, or any other tool that can be used for creating, editing, managing, generating, tracking, consuming or performing any other function or workflow related to content. Digital tools include the creative apparatus 108. A digital tool can allow a user to render, create, edit, and/or export a 3D model.

Digital experience, as described herein, includes experience that can be consumed through an electronic device. Examples of the digital experience include content creating, content editing, content tracking, content publishing, content posting, content printing, content managing, content viewing, content consuming, any combination of these experiences, or any other workflow or function that can be performed related to content. A digital experience can involve rendering, creating, editing, and/or exporting a 3D model.

Content, as described herein, includes electronic content. Examples of the content include, but are not limited to, image, video, website, webpage, user interface, menu item, tool menu, magazine, slideshow, animation, social post, comment, blog, data feed, audio, advertisement, vector graphic, bitmap, document, any combination of one or more content, or any other electronic content. Content can include renderings of a 3D model created and/or edited using the techniques disclosed herein.

Examples of the user devices 102A-N include, but are not limited to, a personal computer (PC), tablet computer, a desktop computer, virtual reality (VR) console, a processing unit, any combination of these devices, or any other suitable device having one or more processors. Each user device includes or is in communication with a user interface such as a display that may include a touch-based or stylus interface. Each user device includes at least one application supported by the creative apparatus 108.

It is to be appreciated that following description is now explained using the user device 102A as an example and any other user device can be used.

Examples of the network 106 include, but are not limited to, internet, local area network (LAN), wireless area network, wired area network, wide area network, and the like.

The creative apparatus 108 includes one or more engines for providing one or more digital experiences to the user. The creative apparatus 108 can be implemented using one or more servers, one or more platforms with corresponding application programming interfaces, cloud infrastructure and the like. In addition, each engine can also be implemented using one or more servers, one or more platforms with corresponding application programming interfaces, cloud infrastructure and the like. The creative apparatus 108 also includes a data storage unit 112. The data storage unit 112 can be implemented as one or more databases or one or more data servers. The data storage unit 112 includes data that is used by the engines of the creative apparatus 108.

A user of the user device 102A visits a webpage or an application store to explore applications supported by the creative apparatus 108. The creative apparatus 108 provides the applications as a software as a service (SaaS), or as a standalone application that can be installed on the user device 102A, or as a combination. The user creates an account with the creative apparatus 108 by providing user details and also by creating login details. Alternatively, the creative apparatus 108 can automatically create login details for the user in response to receipt of the user details. In some embodiments, the user is also prompted to install an application manager. The application manager enables the user to manage installation of various applications supported by the creative apparatus 108 and also to manage other functionalities, such as updates, subscription account and the like, associated with the applications. The user details are received by a user management engine 116 and stored as user data 118 in the data storage unit 112. In some embodiments, the user data 118 further includes account data 120 under which the user details are stored.

The user can either opt for a trial account or can make payment based on type of account or subscription chosen by the user. Alternatively, the payment can be based on product or number of products chosen by the user. Based on payment details of the user, a user operational profile 122 is generated by an entitlement engine 124. The user operational profile 122 is stored in the data storage unit 112 and indicates entitlement of the user to various products or services. The user operational profile 122 also indicates type of user, i.e. free, trial, student, discounted, or paid.

The user management engine 116 and the entitlement engine 124 can be one single engine performing the functionalities of both the engines.

The user then installs various applications supported by the creative apparatus 108 via an application download management engine 126. Application installers or application programs 128 present in the data storage unit 112 are fetched by the application download management engine 126 and made available to the user directly or via the application manager. In one embodiment, all application programs 128 are fetched and provided to the user via an interface of the application manager. In another embodiment, application programs 128 for which the user is eligible based on user's operational profile are displayed to the user. The user then selects the application programs 128 or the applications that the user wants to download. For example, the user may select and download an application program for rendering and/or creating 3D models. The application programs 128 are then downloaded on the user device 102A by the application manager via the application download management engine 126. Corresponding data regarding the download is also updated in the user operational profile 122. An application program 128 is an example of the digital tool. The application download management engine 126 also manages process of providing updates to the user device 102A.

Upon download, installation and launching of an application program, in one embodiment, the user is asked to provide the login details. A check is again made by the user management engine 116 and the entitlement engine 124 to ensure that the user is entitled to use the application program. In another embodiment, direct access is provided to the application program as the user is already logged into the application manager.

The user uses one or more application programs 128 to create one or more projects or assets. In addition, the user also has a workspace within each application program. The workspace, as described herein, includes setting of the application program, setting of tools or setting of user interface provided by the application program, and any other setting or properties specific to the application program. Each user has a workspace. The workspace, the projects or the assets are then stored as application program data 130 in the data storage unit 112 by a synchronization engine 132. The application program data 130 can be specific to the user or can be shared with other users based on rights management. The rights management is performed by a rights management engine 136. Rights management rules or criteria are stored as rights management data 138 in the data storage unit 112.

The application program data 130 includes one or more assets 140. The assets 140 can be a shared asset which the user wants to share with other users or which the user wants to offer on a marketplace. The assets 140 can also be shared across multiple application programs 128. Each asset includes metadata 142. Examples of the metadata 142 include, but are not limited to, color, size, shape, coordinate, a combination of any of these, and the like. In addition, in one embodiment, each asset also includes a file. Examples of the file include, but are not limited to, an image 144 that may include a three-dimensional (3D) model. In another embodiment, an asset only includes the metadata 142.

The application program data 130 also include project data 154 and workspace data 156. In one embodiment, the project data 154 includes the assets 140. In another embodiment, the assets 140 are standalone assets. Similarly, the workspace data 156 can be part of the project data 154 in one embodiment while it may be standalone data in other embodiment.

The user can have one or more user devices. The application program data 130 is accessible by the user from any device, i.e. including the device which was not used to create the assets 140. This is achieved by the synchronization engine 132 that stores the application program data 130 in the data storage unit 112 and makes the application program data 130 available for access by the user or other users via any device. Before accessing the application program data 130 by the user from any other device or by any other user, the user or the other user may need to provide login details for authentication if not already logged in. Else, if the user or the other user are logged in then a newly created asset or updates to the application program data 130 are provided in real time. The rights management engine 136 is also called to determine whether the newly created asset or the updates can be provided to the other user or not. The workspace data 156 enables the synchronization engine 132 to provide same workspace configuration to the user on any other device or to the other user based on the rights management data 138.

In some embodiments, the user interaction with the application programs 128 is also tracked by an application analytics engine 158 and stored as application analytics data 160. The application analytics data 160 includes, for example, usage of a tool, usage of a feature, usage of a workflow, usage of the assets 140, and the like. The application analytics data 160 can include the usage data on a per user basis and can also include the usage data on a per tool basis or per feature basis or per workflow basis or any other basis. The application analytics engine 158 embeds a piece of code in the application programs 128 that enables an application program to collect the usage data and send it to the application analytics engine 158.

In some embodiments, the application analytics data 160 includes data indicating status of project of the user. For example, if the user was preparing an 3D model in a digital 3D model editing application and what was left was printing the 3D model at the time the user quit the application, then the application analytics engine 158 tracks the state. Now when the user next opens the 3D model editing application on another device then the user is indicated the state and the options are provided to the user for printing using the digital 3D model editing application or any other application. In addition, while preparing the 3D model, recommendations can also be made by the synchronization engine 132 to incorporate some of other assets saved by the user and relevant for the 3D model. Such recommendations can be generated using one or more engines as described herein.

The creative apparatus 108 also includes a community engine 164 which enables creation of various communities and collaboration among the communities. A community, as described herein, includes a group of users that share at least one common interest. The community can be closed, i.e. limited to a number of users or can be open, i.e. anyone can participate. The community enables the users to share each other's work and comment or like each other's work. The work includes the application program data 140. The community engine 164 stores any data corresponding to the community, such as work shared on the community and comments or likes received for the work as community data 166. The community data 166 also includes notification data and is used for notifying other users by the community engine in case of any activity related to the work or new work being shared. The community engine 164 works in conjunction with the synchronization engine 132 to provide collaborative workflows to the user. For example, the user can create a 3D model and can request for some expert opinion or expert editing. An expert user can then either edit the image as per the user liking or can provide expert opinion. The editing and providing of the expert opinion by the expert is enabled using the community engine 164 and the synchronization engine 132. In collaborative workflows, each of a plurality of users are assigned different tasks related to the work.

The creative apparatus 108 also includes a marketplace engine 168 for providing a marketplace to one or more users. The marketplace engine 168 enables the user to offer an asset for sale or use. The marketplace engine 168 has access to the assets 140 that the user wants to offer on the marketplace. The creative apparatus 108 also includes a search engine 170 to enable searching of the assets 140 in the marketplace. The search engine 170 is also a part of one or more application programs 128 to enable the user to perform search for the assets 140 or any other type of the application program data 130. The search engine 170 can perform a search for an asset using the metadata 142 or the file.

It is to be appreciated that the engines and working of the engines are described as examples herein and the engines can be used for performing any step in providing digital experience to the user.

### Exemplary System for Three-Dimensional Image Manipulation

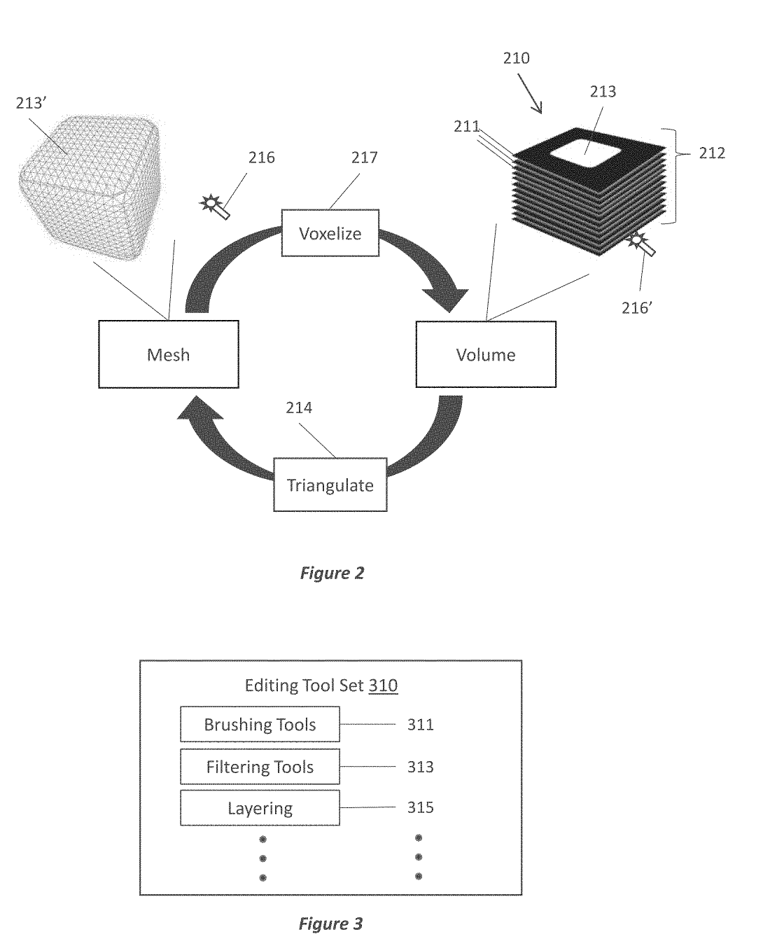

FIG. 2 illustrates a cycle of processes performed by an exemplary application program (e.g., application programs 128, application 104A, etc.) configured as a system for three-dimensional (3D) model manipulation. The exemplary processes synchronize two different representations of a 3D model 213. Specifically, the processes synchronize a volume density data structure 210 representing the 3D model 213 with a mesh representation 213′ of the 3D model 213. This allows the two different representations of the 3D model 213 to be maintained and used for multiple and different purposes by the application program. In one embodiment of the invention, the volume density data structure 210 of the 3D model 213 is used to implement creation and editing tools in the application program. The mesh representation 213′ of the 3D model 213 is used to render and/or export the 3D model 213. This greatly expands the types of edits and the editing tools that users can use to edit 3D models beyond the conventional mesh-based editing features provided by conventional mesh-only 3D editing applications.

Generally, the volume density data structure 210 represents density at different locations in a 3D workspace. In one example, the density at a particular x, y, z location (x1, y1, z1) is 9, at another particular x, y, z location (x2, y1, z1) is 11, at the density at another particular x, y, z location (x3, y1, z1) is 12, etc. Such density values for many x, y, z locations in the 3D workspace 212 can be represented by a volume density data structure 210. These volume density values represent the density of the 3D model at these x, y, z locations.

The volume density data structure 210 in the example of FIG. 2 is illustrated as stack of grey scale images or cross sections 211 containing a series of cross-sectional representations of a three-dimensional workspace 212. In this example, there is a different cross section for many z values in the 3D workspace 212. Each cross section thus provides the density values for each x, y location on the cross section. In the above example in the z1 cross section, the density values of (x1, y1) is 9, at (x2, y1) is 11, and at (x3, y1) is 12. The density values in a cross section can be represented graphically as a greyscale image, with higher density values being displayed using relatively darker shades of gray. Alternatively, the density values in a cross section could be displayed using colors, numbers, or any other appropriate representation. While representations of the volume density data structure 210 can be provided for display in an editing interface, the volume density data structure 210 need not be displayed. In embodiments of the invention, the volume density data structure 210 is only used to apply user edits to the 3D model without being displayed to the user, as explained next.

The volume density data structure 210 is used by the application program to implement edits. For example, based on user input identifying to add to the 3D model in an area in the 3D workspace 212, the density values in that area are increased. For example, a user can provide input via the application program to add content in an area around a location (x3, y3, z3) with a radius 10 units (e.g., pixels/cross sections). Such input can be provided using a 3D paint brush tool with a spherical shape. In this example, based on this input, the application program determines to add density to any location in the volume density data structure within 10 units (e.g., pixels) of that location. The density values can be uniformly increased, for example, so that all density values within the radius are increased by the same amount. Alternatively, the density values can be increased based on distance away from that location. For example, density values of locations closer to the location (x3, y3, z3) can be increased more than the density values of locations that are relatively further from that location. Density values outside of the radius are not increased in this example.

In the example of FIG. 2 in which the volume density data structure comprises cross sections 211, the exemplary radius-based edit results in editing the density values in circular regions in each of the cross sections 211. Specifically, the density values in a circular region around (x3, y3) in a z3 cross section will be increased, the density values in slightly smaller circular regions around (x3, y3) in each of a z3+1 and z3−1 cross sections will be increased, etc. In this way, the spherical edit (i.e., the edit adding density in a sphere) is implemented by adding density in a circular area in several cross sections in a stack of cross sections. Generally, edits can effect 3D areas of the workspace and those edits are implemented by determining and changing the volume density values at locations within those 3D areas.

Note that the distances between neighboring cross sections of cross sections 211 can be, but need not be, the same as the distance between neighboring pixels in the cross sections. Thus, the number of cross sections can be selected so that the resolution in the z direction is the same as the resolutions in the x and y directions. For example, where each cross section is a 1000×1000 image of pixel values representing densities for different x,y locations, there can be 1000 different cross sections representing different z planes in the z direction. In this way, the collection of cross sections 211 collectively represents the 3D workspace 212 using 1000 cross sections, each having 1000×1000 pixels representing density values. This represents a 3D workspace 212 with dimensions 1000×1000×1000. The number and configuration of the cross sections and the pixels within each cross section can be selected to balance resolution and/or processing efficiency. For example, the number of cross sections and/or image pixels can be reduced to improve efficiency or increased to improve resolution.

FIG. 2 illustrates a triangulate 214 process to illustrate an exemplary process of determining a mesh representation 213′ based on the density volume data structure 210 representing the 3D model 213. Generally, this conversion involves determining a surface around density values that are above a threshold in the density volume data structure 210. For example, consider the above example in which the density at a first x, y, z location (x1, y1, z1) is 9, at a second x, y, z location (x2, y1, z1) is 11, at the density at a third x, y, z location (x3, y1, z1) is 12, etc. If the threshold is 10, the conversion process involves determining a surface around locations having a density of 10 or more. In the present example, the surface would surround the second and third locations would but not the first location based on their respective density values. In FIG. 2, this conversion determines the surface using a triangulate 214 process involves determining a surface that is defined using a mesh of interconnected triangles. Determining a surface surrounding locations in a density volume representation having a density values above a threshold can involve determining one or more continuous functions that specify the surface. Various known algorithms, such as a Marching Cubes, Dual Contouring, Surface Nets and Marching Tetrahedrons, can be used to determine functions that represent one or more surfaces based on volume density information. For example, the Marching Cubes algorithm creates a surface by intersecting the edges of a volume grid with a volume contour. Where the surface intersects the edge, the algorithm creates a vertex. By using a table of different triangles depending on different patterns of edge intersections, the algorithm creates a surface.

The mesh representation 213′ of the 3D model can be used to display a rendering. The mesh representation 213′ of the 3D model 213 is especially useful in providing an editable rendering of the 3D model on a graphical user interface (GUI). The surface of the 3D model is displayed on such a GUI and the user is able to view the surface of the 3D model. Thus, like conventional 3D model editing systems, the user is able to view renderings of a mesh-based representation of the 3D model 213. However, because the 3D model 213 also has a density volume data structure 210, the user is able to edit the model in ways that conventional 3D model editing systems could not. Specifically, the user is able to make edits that change the volume representation rather than having to make edits by interacting with vertices of a rendering on the mesh representation.

A user (not shown) uses an input device, such as a mouse, trackpad, keyboard, touchscreen, etc., to control an editing tool 216, such as brush, filter, pen, layer, etc., on a display depicting the mesh representation 213′. Thus even though the user is viewing the mesh representation 213′, the user is able to make edits that are implemented using the volume density data structure 210. As the user operates the editing tool 216, the application determines locations within the 3D workspace 212 that the user is interacting with. For example, if the user positions editing tool 216, such as a paint brush, on the user interface near (but not touching) an edge of the mesh representation 213′, the application can determine a location in the 3D workspace 212 based on the position of the editing tool 216. In one example, the application identifies two of dimensions of the location of the edit based on the position of the editing tool and determines the third dimension automatically. In another embodiment, the user moves the component in a first dimension (e.g., x) by moving a cursor left and right, a second dimension (e.g., z) by moving the cursor up and down, and a third direction (e.g., “y” by pressing a “f” or a “b” respectively for “front” and “back”). The size of the cursor in this embodiment can increase and/or decrease to graphically indicate the depth of the cursor in the third direction. Generally, the user positions an editing tool 216 relative to the mesh representation ′213 displayed on an editing canvas and specifies edits to the model. Additionally, or alternatively, the user can edit the model by specifying filters, layers, and using other features that specify how an area of the 3D workspace 212 should be changed. Additionally, or alternatively, the user can make edits that directly change the mesh representation 213′ for example by dragging a vertices of the mesh representation 213′ to a new location.

Based on receiving an edit, the application modifies the corresponding locations on the stack of images 211 based on defined properties of the tool 216 as further discussed below. The mesh representation 213′ is displayed and the user makes edits relative to the interface that displays the mesh representation 213′. The edits are interpreted and used to change the density volume data structure 210. Moreover, the edits can be implemented in the density volume data structure 210. The triangulate 214 process then modifies the mesh representation 213′ and the user interface updated in real time. Thus, as a user uses a paint brush tool to make brush strokes adding to the 3D model, the user interface is updated during the brush stroke. More specifically, the user is able to see the how the mesh has changed based on the content added at the beginning of the brush stroke as the user completes the rest of the brush stroke. Generally, during or after each edit, the triangulate 214 process of FIG. 2 repeats and converts the modified volume representation to a modified mesh representation 213′, which is used to update the user interface.

FIG. 2 further illustrates a voxelize 217 process as an example of a process for converting the mesh representation 213′ to the volume based representation in the density volume data structure 210. Such a conversion can occur at an initial stage of use, for example, where a user imports a mesh representation from another application. Converting the mesh representation 213′ to the density volume data structure 210 can also occur to synchronize changes made directly to the mesh, for example, where a user drags a mesh representation 213′ vertices to a new location. Generally, converting from a mesh to a volume representation comprises determining density values for different locations in the 3D workspace 212 based on a surface defined by a mesh. In one example, this involves assigning the same predetermined density value for all locations within the surface area defined by the mesh representation 213′. In another example, this conversion involves assigning density values based on distances from the surface area. For example, density values just inside the surface can be higher than density values that are further within the surface. In addition, small values below a threshold (e.g., below 10 in the above example) can be assigned to locations just outside (e.g., within 5) pixels of the surface. In one embodiment of the invention the processes of FIG. 2 begin with a mesh representation of a 3D model and the application converts the 3D model into a volume based representation stored in a density volume data structure 210 as the start of the processes.

FIG. 2 illustrates using an exemplary voxelize 217 process to convert the mesh representation 213′ into a density volume data structure 210. In this example, the voxelize 217 process does the inverse of the triangulate 214 process. Specifically, voxelize 217 process converts the triangles or other polygons of the mesh representation 213′ into density values in a grid to form the density volume data structure 210. In one embodiment of the invention, the voxelize 217 process is used only when a mesh representation is imported. In another embodiment of the invention, the voxelize 217 process is used to convert changes made directly to the mesh representation 213′ to the density volume data structure 210, for example, based on a user directly moving vertices of the mesh representation 213′. One exemplary technique for performing the voxelize 217 process involves computing for every point (x,y,z) a signed distance to the mesh representation 213′. The technique then splits the signed distance into two parts: an unsigned distance and the sign. The sign is determined based on whether the point (x,y,z) lies inside or outside of the mesh representation 213′. The distance is computed as the minimum of the distance (point(x,y,z), triangle(i)) for all triangles i in the mesh. A linear mapping is then performed to get a density value for every point on the grid. This can involve, for example, determining density using the equation: density (signeddistance)=max(min(signeddistance*a+b,1),0)), with clamping between signed distance and density. In this example, “a” refers to scale and “b” refers to mesh offset. One embodiment of the invention provides predetermined values for the scale (e.g., 0.5) and mesh offset (e.g., 0.5). In an alternative embodiment of the invention, these values are adjusted based on user input to allow user control of the voxelize 217 and/or triangulate 214 processes.

In certain embodiments of the invention, the voxelize 217 and/or triangulate 214 processes of FIG. 2 are selectively performed on only the edited regions of the 3D model 213. In one example, when an edit is performed, an area of the 3D workspace 212 affected by the edit is determined. Changes to the density volume data structure 213′ are then limited to this area. Then, the triangulate process is performed to only change the mesh representation ′213 for the limited changes made to the volume data structure 213′. For example, this can involve determining a surface surrounding the volume densities within the limited area and then replacing the portions of the mesh representation 213′ in this area with the newly-determined mesh portions. In this embodiment of the invention, the synchronization processes are simplified to improve the speed and efficiency of the invention. At periodic intervals, for example once per minute, once every 5 minutes, etc., a full synchronization can be performed to correct for inconsistencies.

FIG. 3 illustrates an exemplary editing tool set 310 for the user to select from. Different tools are used to edit the 3D model 213 in different ways. For example, brushing tools 311 are used to apply one of a variety of edits as further discussed below to discrete portions of the 3D model using a pointing device or touch-based interface.

Filtering tools 313 are used to apply an edit to an area of a 3D workspace to edit the 3D model. The area of the 3D workspace can be selected by a user selecting the area or areas to be edited. The selections of such an area or areas may be made manually, for example by drawing a border around the desired selection; or with system assistance, for example by selecting areas having common attributes such as color. The selected areas of the 3D model may have a selection mask applied that excludes areas outside the selection. The selected areas may be saved in a new 3D workspace with only the selection masked portion as the 3D model in the new workspace.

Layering 315 includes defining additional 3D workspaces for additional 3D models. The several 3D workspaces may then be edited independently or merged with each other, for example mathematically or otherwise combined into a single 3D model. As a specific example, consider a user defining one 3D model depicting a peach with a bite out of it and another 3D model in another 3D workspace depicting the pit or seed. Once each model is complete, the user may combine the separate 3D workspaces together so that a representation of a peach with a bite revealing part of the pit is displayed. As another example, the user may “subtract” the pit layer from the peach layer and cross section the combination so that a representation of a peach showing pit texture in the flesh is displayed. As another example, the user may select only one 3D workspace at a time for display and editing, or the user may select two or more 3D workspaces for display and editing.

Regardless of the method of selecting areas for editing, either brushing, filtering or layering, or any other editing technique, the system supplies a selection of various well-understood editing tools to the user. For example, the user may use a brush tool to draw, paint, smudge, blur or clone an area of the 3D model 213. In use, the system applies a selected tool at a selected location indicated by the user on the display to edit volume densities of specific elements in the volume-based representation corresponding to the selected location. The selected tool may include a user selectable 3D volume shape and size of application, such as a paint brush defining a spherical application volume having a selected radius. As another example, the user may select an area and apply a filter such as blur, add noise, sharpen, or pixelate to the 3D model 213. In use, the system identifies an area, such as a user selected portion of the surface of the 3D model indicated on the display, and applies a filter, such as a Gaussian blur to the volume density values of elements within the volume-based representation at an area corresponding to the user selected portion of the 3D model shown on the display.

Embodiments of the invention provide techniques, systems, and computer-readable mediums with stored instructions that enable 3D model editing and rendering. The functions involved in these embodiments of the invention generally involve representing the 3D model using both a volume-based representation and a mesh-based representation, providing views of the 3D model for display on a user interface based on the mesh-based representation, and editing the 3D model based on edits received on the user interface by modifying the volume-based representation of the 3D model. These functions are generally implemented on one or more computing devices by performing one or more acts using one or more processors to execute algorithms of one or more operations defined in stored instructions. The operations of various exemplary algorithms that can be employed to perform these functions are illustrated in the FIGURES and throughout this specification.

The function of representing the 3D model using both a volume-based representation and a mesh-based representation can be performed using one or more computing devices implementing various algorithms by executing stored instructions. The algorithms can include any of the exemplary techniques disclosed herein as well as modifications to the techniques herein to address particular circumstances of an implementation. The function can be performed by performing one or more acts according to these algorithms. An exemplary algorithm for representing the 3D model using both a volume-based representation and a mesh-based representation involves synchronizing the different representations with one another using a triangulate, voxelize, and/or other conversion technique. Another exemplary algorithm involves implementing all changes (e.g., user edits) in the volume-based representations and updating the mesh representation based on those changes. Another exemplary algorithm, involves receiving a 3D model from an external system and then determining the volume-based representation and the mesh-based representation from the received 3D model. This can involve first converting the 3D model to the volume-based representation and then converting the volume-based representation into the mesh-based representation. Alternatively, it can involve first converting the 3D model to the mesh-based representation and then converting the mesh-based representation into the volume-based representation. Alternatively, it can involve separately converting the received 3D model into each of the mesh-based and volume-based representations. Accordingly, 3D models that use non-mesh-based and non-volume-based representations can be received and edited using techniques disclosed herein.

The function of providing a view of the 3D model for display on a user interface based on the mesh-based representation can be performed using one or more computing devices implementing various algorithms by executing stored instructions. The algorithms can include any of the exemplary techniques disclosed herein as well as modifications to the techniques herein to address particular circumstances of an implementation. The function can be performed by performing one or more acts according to these algorithms. An exemplary algorithm for providing a view of the 3D model for display on a user interface based on the mesh-based representation involves receiving the mesh-based representation, determining a view direction relative the 3D model, determining a portion of the mesh-based representation to display based on the view direction relative to the 3D model, determining coordinate locations in a 3D space using x, y, z coordinates for vertices, surfaces, or other attributes of the portion of the mesh-based representation, and displaying a rendering of those attributes. Another exemplary algorithm can involve creating a 2D rendering of the 3D model given a view direction. Another exemplary algorithm involves providing a 3D editing interface that allows user control of a “camera” or “viewer” position relative to the 3D model to control the view direction. In this example, the view of the 3D model that is displayed depends upon the user specified camera/viewer position relative to the 3D model. Another exemplary algorithm involves receiving the mesh-based representation of the 3D model and generating a virtual reality interface that positions the mesh-based representation in a 3D space using x, y, z coordinates for vertices, surfaces, or other attributes of the mesh-based representation. Another exemplary algorithm comprises determining a change to an existing view based on a change to the mesh-based representation. For example, this can involve determining a portion of the mesh-based representation that has changed, determining an edit to a portion of a displayed view based on the change, and changing the portion of the view based on the portion of the mesh-based representation that has changed.

The function of editing the 3D model by modifying the volume-based representation based on an edit received from a user interacting with the user interface can be performed using one or more computing devices implementing various algorithms by executing stored instructions. The algorithms can include any of the exemplary techniques disclosed herein as well as modifications to the techniques herein to address particular circumstances of an implementation. The function can be performed by performing one or more acts according to these algorithms. An exemplary algorithm for editing the 3D model by modifying the volume-based representation based on an edit received from a user interacting with the user interface comprises determining one or more locations within a 3D workspace corresponding to the edit and modifying volume density values of the one or more locations based on the edit.

Another exemplary algorithm for editing the 3D model by modifying the volume-based representation involves identifying a set of locations in a 3D workspace based on a position of the edit relative to the view of the 3D model displayed on the user interface, determining a type of the edit, and determining a modified volume-based representation by increasing or decreasing volume density values of the second set of locations based on the type of the edit.

Another exemplary algorithm for editing the 3D model by modifying the volume-based representation involves receiving a first input identifying a location on the user interface, receiving a second input identifying a filter to be applied to the 3D model, and modifying the volume-based representation by applying the filter to volume density values based on the location. Another exemplary algorithm involves receiving input to add a layer the 3D model, creating a new layer to represent density values in a new 3D workspace, and adding the new layer to the set of layers. The density values from layers of the set of layers can be combined to represent the 3D model.

Another exemplary algorithm for editing the 3D model by modifying the volume-based representation involves receiving input to edit the 3D model based on a position of a brush on the user interface, identifying a location in a 3D workspace corresponding to the position of the brush, and modifying volume density values at the location. The algorithm can additionally involve sensing pressure applied by an input device at the position and modifying the density values based on the pressure.

Another exemplary algorithm for editing the 3D model by modifying the volume-based representation involves receiving input to edit the 3D model based on a stroke of a brush through multiple positions on the user interface, identifying locations in a 3D workspace corresponding to the positions of the brush during the stroke; and modifying volume density values at the locations.

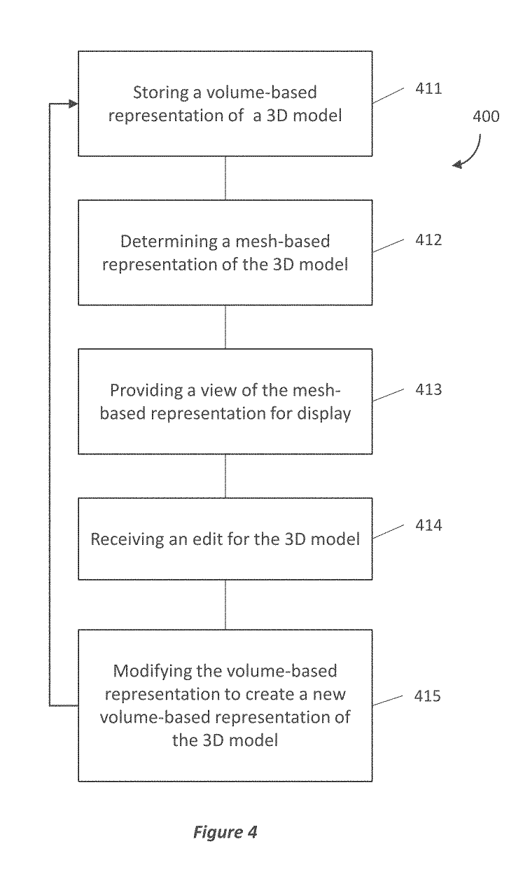

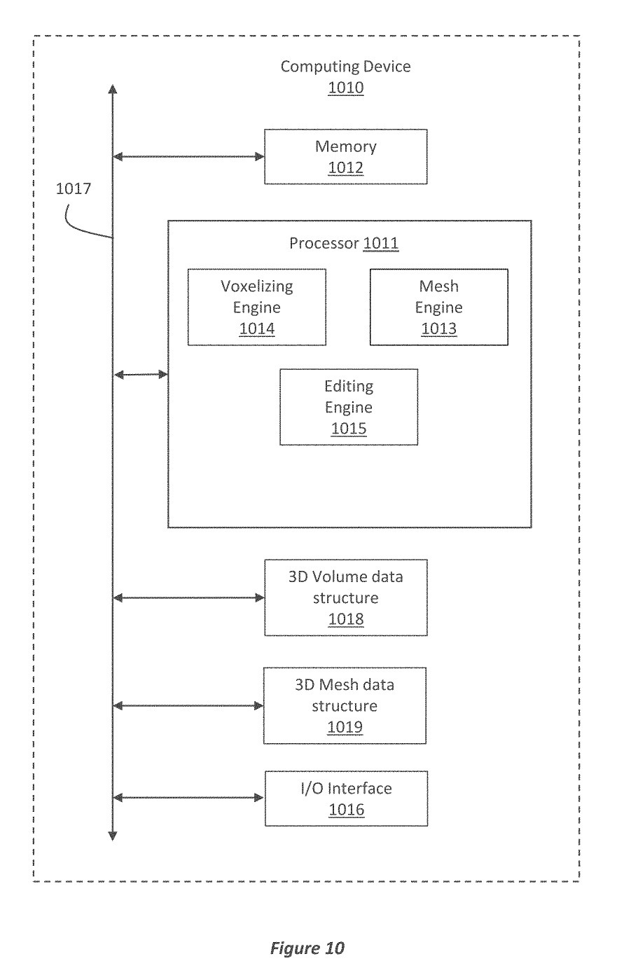

FIG. 4 is a flow chart illustrating an exemplary computer implemented method 400 for creating or editing a three-dimensional model. Exemplary method 400 is performed by one or more processors of one or more computing devices such as computing devices of FIG. 1 or 10. Method 400 can be implemented by a processor executing instructions stored in a non-transitory computer-readable medium.

Method 400 includes representing a first representation of a 3D model as a volume-based representation, shown in block 411. As used herein, the description will refer to a “first” and a “second” representation, for example, intending to discuss the 3D workspace before an edit and following an edit respectively. It is appreciated that a great number of iterations will occur and the nomenclature is intended to represent only specific instances and states before and after specific, but perhaps continuing, edits. The first volume-based representation identifies volume densities of the 3D model at multiple locations in a 3D workspace. In one example, the first volume-based representation of a 3D model is arranged as stack of cross-sectional cross sections through the 3D workspace. Each point within each cross section represents a density value of the 3D model at that point. As discussed herein, these density values are used to determine a surface of the 3D model, for example, where the surface surrounds all density values above a predetermined or user-specified threshold.

The method 400 further includes determining a first mesh-based representation of the 3D model based on the first volume-based representation, as shown in block 412. The mesh-based representation of the 3D model can be determined by an algorithm operating on the first volume-based representation. Embodiments of the invention, including but not limited to the method 400 may employ one such algorithm known as “marching cubes” that uses density values to identify surfaces of the 3D model and create geometric shapes that depict the surface. The method identifies a mesh surrounding a set of locations within the 3D workspace having volume density values above or below a threshold where the threshold interface is deemed to identity the surface of the 3D model. For example, values above the threshold may be identified as included in 3D model and values below may be identified as excluded from the 3D model. The method 400 may apply the algorithm to the entire volume-based 3D workspace, or limit application of the algorithm to a known edited region of the volume-based 3D model to improve efficiency and rendering speed.

The method 400 further includes providing a first view of the first mesh-based representation of the 3D model for display, for example, on a user interface, as shown in block 413. In embodiments, the system and method receive view related commands from a user that may include zoom; pan left, right or out; rotate about an axis, vary transparency, and the like.

The method 400 further includes receiving an edit for the 3D model, as shown in block 414. For example, a user may use computer implemented editing tools to interact with the displayed 3D representation and indicate desired edits which are received by the method. Typically, the edit will include an input identifying a location and tool data to be applied to the 3D model. As a specific example, a user may position a brush configured as drawing tool with a selected tip shape and size within the 3D workspace. The user may move or “drag” the tool in a direction indicative of the desired edit, which in this example is adding to or creating a 3D model at the location and at locations along the direction of tool movement.

As another example, a user may select a desired tool, such as “paint” or “erase,” and indicate desired edit locations on a touch-based user interface with a finger, multiple fingers, a stylus, or the like. In instances where edits are received on a touch-based user interface, the method may further receive an indication of the pressure applied to the interface and increase the 3D area of application of the edit for instances of increased pressure, and decrease the 3D area of application of the edit for instances of decreased pressure.

Additionally, because the received edit is not applied to specific vertices in the mesh-based representation, the edit will be implemented even if the edit location on the user interface does not correspond precisely to a surface feature of the mesh-based representation of the 3D model.

Receiving the edit for the 3D model also includes receiving data regarding specific desired editing tools. For example, the edit may include data identifying a location and tool data to be applied to the 3D model. A user may select areas to apply a filter, selection mask or separate 3D layer for editing. In the case of a brush tool, the edit may include shape and 3D radius to which the edit is to be applied.

The method 400 further includes modifying the first representation based on the edit to create a second volume-based representation of the 3D model, as shown in block 415. Modifying the first volume-based representation includes modifying the volume densities representing the 3D model. For example, when the user drags the drawing tool in the 3D workspace displayed on the user interface, the method modifies the separate, volume-based 3D workspace to increase volume densities at the location and along the direction of tool movement in those 2D cross sections thereby adding to or creating the 3D model. In other words, based on tool characteristics and location on the user interface, the volume density is increased at corresponding locations in the volume-based representation of the 3D workspace.

The method 400 then recursively repeats the steps until editing is complete.

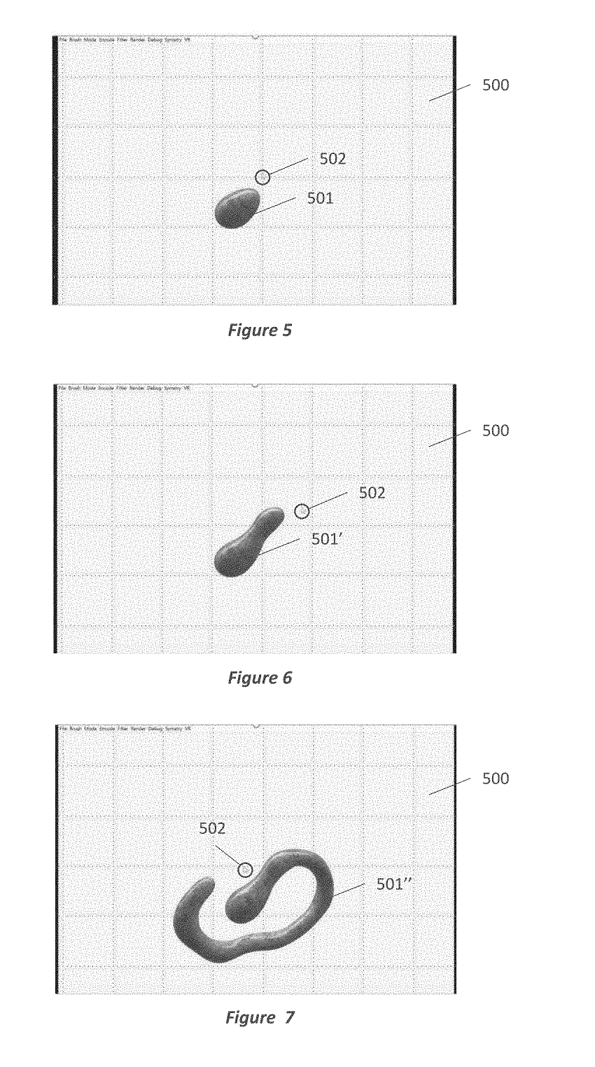

FIGS. 5, 6 and 7 are screen shot captures illustrating use of one embodiment of a system and method for editing a three-dimensional 3D model 501. The Figures illustrate a user interface 500 displaying a 3D model 501. A user selects an editing mode, for example here a drawing brush indicated by pointer 502. With reference to FIG. 5, the user places the pointer 502 in a desired location and commences the edit, here drawing, by moving the pointer 502 up and right relative to the user interface 500. While the user moves the pointer 502 relative to the 3D model 501 within the 3D workspace, the system tracks the location and applies the edits to the volume densities at corresponding locations within the volume-based representation rather than directly interacting with the surface of the mesh. The edited 3D model 501′ is seen in FIG. 6 and pointer 502 continues to move now in a downward and left loop relative to the user interface 500 as the system recursively tracks the location in the mesh-based representation of the 3D workspace and applies the edits in the volume-based representation of the 3D workspace. The subsequently edited model 501″ is seen in FIG. 7. The screen shots have been selected to illustrate one embodiment of the disclosure.

Again, as the pointer 502 moves across the user interface, edits are made to density values of affected locations in the 2D cross sections comprising the volume-based representation. The newly edited volume-based representation is then used to generate a newly edited mesh-based representation to display the 3D model in real-time or near real-time on the user interface. Of course, other tools may be used for other features including but not limited to “erasing,” “scraping,” and “distorting” an area of the model indicated by the pointer.

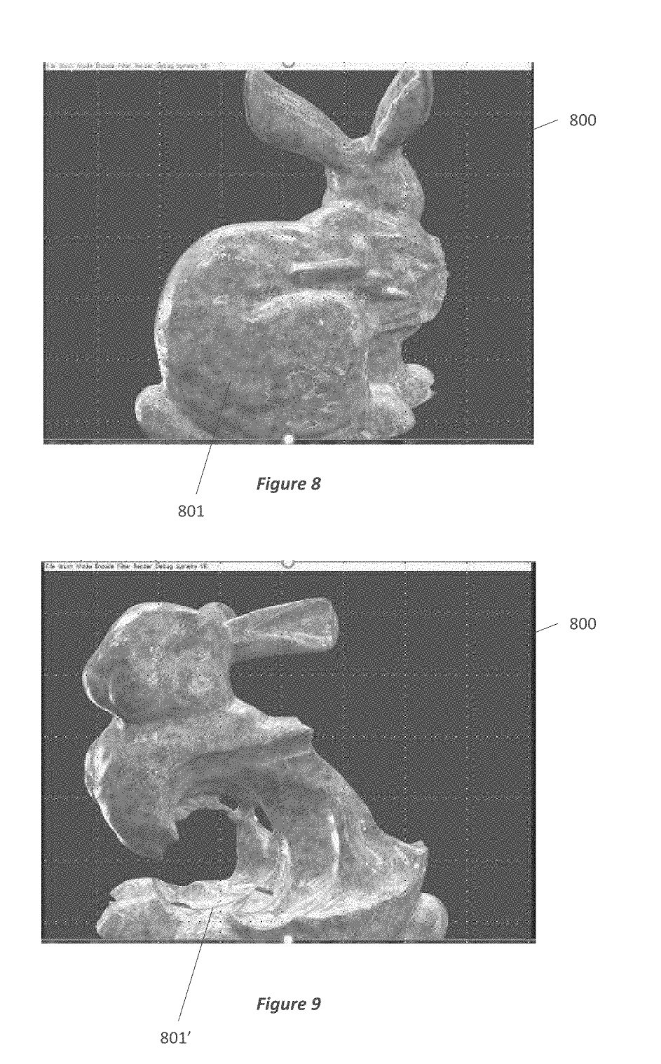

FIGS. 8 and 9 depict before and after screen shot captures of one embodiment of a system and method for editing a three-dimensional 3D model 801. With reference to FIG. 8, a user selects a tool and an editing mode, for example an erasing brush implemented on a touch-based interface although a VII interface could be substituted. The user applies a pressure on the interface at a desired location and commences the edit. In this example, the user is erasing by moving a finger or stylus over the body area to be removed where increased pressure expands and decreased pressure contracts the edited area within the volume. Similarly, as the user moves across the user interface, edits are made to density values of affected locations in the 2D cross sections comprising the volume-based representation. The newly edited volume-based representation is then used to generate a newly edited mesh-based representation to display the 3D model in real-time or near real-time on the user interface 800. Additionally, for convenience, the system may permit the user to selectively rotate the 3D model along any axis during an edit. The edited 3D model 801′ is seen in FIG. 9.

Any suitable computing system or group of computing systems can be used to implement the techniques and methods disclosed herein. For example, FIG. 10 is a block diagram depicting one exemplary implementation of such components. A computing device 1010 can include a processor 1011 that is communicatively coupled to a memory 1012 and that executes computer-executable program code and/or accesses information stored in memory 1012. The processor 1011 may comprise a microprocessor, an application-specific integrated circuit (“ASIC”), a state machine, or other processing device. The processor 1011 can include one processing device or more than one processing device. Such a processor can include or may be in communication with a computer-readable medium, including but not limited to memory 1012, storing instructions that, when executed by the processor 1011, cause the processor to perform the operations described herein.

The memory 1012 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, memory chip, ROM, RAM, an ASIC, a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, Visual Basic, Java, Python, Perl, JavaScript, and ActionScript.

The computing device 1010 executes program code that configures the processor 1011 to perform one or more of the operations described above. Specifically, and without limitation, the program code can include code to configure the processor as a mesh engine 1013, a voxelizing engine 1014 and editing engine 1015. The program code may be resident in the memory 1012 or any suitable computer-readable medium and may be executed by the processor 1011 or any other suitable processor. In some embodiments, modules can be resident in the memory 1012. In additional or alternative embodiments, one or more modules can be resident in a memory that is accessible via a data network, such as a memory accessible to a cloud service.

The computing device 1010 may also comprise a number of external or internal devices such as input or output devices. For example, the computing device is shown with an input/output (“I/O”) interface 1016 that can receive input from input devices or provide output to output devices. The I/O interface 1016 can include any device or group of devices suitable for establishing a wired or wireless data connection to one or more data networks. Non-limiting examples of the interface 1016 include an Ethernet network adapter, a modem, and/or the like. The computing device 1010 can transmit messages as electronic or optical signals via the interface 1016. A bus 1017 can also be included to communicatively couple one or more components of the computing device 1010.

In one embodiment, processor 1011 stores a volume-based representation of a 3D model in a 3D Volume data structure 1018. Mesh engine 1013 then determines a mesh-based representation of the 3D model which is stored in 3D Mesh data structure 1019. Processor 1011 provides the mesh-based representation to a display (not shown) through the I/O interface 1016 for display on a user interface (not shown). A user interacts with editing tools and the 3D model as displayed, and processor implements the edits on the 3D Volume representation stored in data structure 1018. Processor 1011 causes mesh engine 1013 to determine a new mesh-based representation of the 3D model including the edits which are provided to the display (not shown) through the I/O interface 1016.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure the claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

What is claimed is:

1. A method, performed by a computing device, for editing a three-dimensional (3D) model, the method comprising:
representing the 3D model using a first volume-based representation;
determining a first mesh-based representation of the 3D model from the volume-based representation;
providing a first view of the first mesh-based representation of the 3D model for display on a user interface;
receiving an edit for the 3D model from a user interacting with the user interface;
modifying the first volume-based representation based on the edit to create a second volume-based representation of the 3D model;
determining a second mesh-based representation of the 3D model based on the second volume-based representation; and
providing a second view of the second mesh-based representation of the 3D model for display on the user interface.

2. The method as set forth in claim 1, wherein representing the 3D model using the first volume-based representation comprises representing the 3D model using volume density values of locations within a 3D workspace, wherein the 3D model is represented by a set of the locations having volume density values above a threshold.

3. The method as set forth in claim 2, wherein modifying the first volume-based representation comprises modifying the volume density values of locations within the 3D workspace based on the edit.

4. The method as set forth in claim 1, wherein representing the 3D model using the first mesh-based representation comprises representing a surface of the 3D model using a plurality of interconnected polygon surfaces.

5. The method as set forth in claim 1, wherein representing the 3D model using the first mesh-based representation comprises identifying a mesh surrounding the set of locations within the 3D workspace having volume density values above the threshold in the first volume-based representation.

6. The method as set forth in claim 1, wherein modifying the first volume-based representation comprises:
identifying a set of locations in a 3D workspace based on a position of the edit relative to the view of the 3D model displayed on the user interface;
determining a type of the edit; and
determining the second volume-based representation by increasing or decreasing volume density values of the second set of locations in the first volume-based representation based on the type of the edit.

7. The method as set forth in claim 1, wherein determining the second mesh-based representation comprises determining the second mesh-based representation based on the second volume-based representation using a triangulate process.

8. The method as set forth in claim 1, wherein the step for editing the 3D model comprises modifying a plurality of parallel, planar, cross-sections of a 3D workspace, wherein the cross-sections comprise 2 dimensional (2D) grey scale representations of volume density values of the 3D model.

9. The method as set forth in claim 1, wherein receiving the edit for the 3D model comprises receiving an input identifying a location on the user interface that is not on a vertices or surface of the first mesh-based representation of the 3D model.

10. The method as set forth in claim 1,
wherein receiving the edit for the 3D model comprises receiving a first input identifying a location on the user interface and receiving a second input identifying a filter to be applied to the 3D model; and
wherein modifying the first volume-based representation comprises modifying the first volume-based representation by applying the filter to volume density values based on the location.

11. The method as set forth in claim 10, wherein receiving the first input identifying the location comprises receiving a selection of a selection mask identifying the location.

12. The method as set forth in claim 1,
wherein receiving the edit for the 3D model comprises receiving input to add a layer the 3D model, wherein the first volume-based representation represents the 3D model by specifying density values for the 3D model using a set of one or more layers, each of the one or more layers separately representing density values for locations in a separate 3D workspace; and
wherein modifying the first volume-based representation comprises:
creating a new layer to represent density values in a new 3D workspace;
adding the new layer to the set of layers; and
combining density values from layers of the set of layers to represent the 3D model.

13. The method as set forth in claim 1,
wherein receiving the edit for the 3D model comprises receiving input to edit the 3D model based on a position of a brush on the user interface; and
wherein modifying the first volume-based representation comprises:
identifying a location in a 3D workspace corresponding to the position of the brush;
sensing pressure applied by an input device at the position; and
modifying volume density values at the location based on the sensed pressure.

14. The method as forth in claim 1,
wherein receiving the edit for the 3D model comprises receiving input to edit the 3D model based on a stroke of a brush through multiple positions on the user interface; and
wherein modifying the first volume-based representation comprises:
identifying locations in a 3D workspace corresponding to the positions of the brush during the stroke; and
modifying volume density values at the locations.

15. The method as set forth in claim 1, wherein receiving the edit for the 3D model comprises receiving the edit from a touch-based interface or via a virtual reality (VR) interface.

16. A computer-based system for editing a three-dimensional (3D) model, the system comprising:
a means for representing the 3D model using a volume-based representation;
a means for representing the 3D model using a mesh-based representation;
a means for providing a view of the 3D model for display on a user interface based on the mesh-based representation; and
a means for editing the 3D model by modifying the volume-based representation based on an edit received from a user interacting with the user interface.

17. The computer-based system as set forth in claim 16, wherein the means for editing the 3D model comprises a means for increasing or decreasing volume density values of a set of locations in the volume-based representation.

18. A non-transitory computer-readable medium comprising instructions for causing a computing device to perform operations comprising:
representing the 3D model using a volume-based representation and a mesh-based representation;
displaying the 3D model on a user interface based on the mesh-based representation; and
editing the 3D model based on edits received from a user interacting with the user interface by modifying the volume-based representation of the 3D model.

19. The non-transitory computer-readable medium of claim 18, wherein representing the 3D model using the volume-based representation and the mesh-based representation comprises determining the mesh-based representation by identifying a mesh surrounding locations within the 3D workspace having volume density values above a threshold in the volume-based representation.

20. The non-transitory computer-readable medium of claim 18, wherein editing the 3D model comprises:
identifying a set of locations in a 3D workspace based on a position of the edit relative to the view of the 3D model displayed on the user interface;
determining a type of the edit;
determining a modified volume-based representation by increasing or decreasing volume density values of the second set of locations based on the type of the edit; and
determining a modified mesh-based representation based on the modified volume-based representation.
